(19) United States
(12) Patent Application Publication
(10) Pub. No.: US 2009/0111068 A1
(43) Pub. Date: Apr. 30, 2009

(54) Irrigation and Aspiration Device

(76) Inventor: Daniel L. Martinez, Albuquerque, NM (US)

Correspondence Address: V. Gerald Grafe, esq., P.O. Box 2689, Corrales, NM, 87048, US

(21) Appl. No.: 11/929,362

(22) Filed: Oct. 30, 2007

(51) Int. Cl. A61C 5/02

(52) U.S. Cl. 433/81

(57) ABSTRACT

An irrigation and aspiration device comprises a probe and an aspiration sleeve that ensheathes the probe. The aspiration sleeve prevents the insertion of the probe beyond a desired distance, thereby preventing perforation of the apex of a root canal or wound, and also aspirates any excess irrigation solution and free debris. The device can be used for endodontic and periodontal procedures, penetrating or tract wound irrigation, open or superficial non-penetrating wound irrigation, and irrigation during specialty surgeries in endoscopic, opthalmology, gynecology, orthopedic surgery, and other specialty surgeries.

### FIELD OF THE INVENTION

This invention is in the field of instruments for use in medicine and dentistry. More specifically, this invention is in the field of irrigator probes and syringes for irrigating root canals as part of a root canal procedure and for irrigating wounds in the field of trauma and surgery.

### BACKGROUND OF THE INVENTION

To preserve a tooth that has a diseased pulp cavity, it is necessary to prevent bacterial proliferation within the pulp canal of the tooth by removing the diseased or necrotic pulp material from the pulp canal. After the pulp material has been removed or extirpated from a tooth, the pulp cavity is typically filled or obturated with a material such as gutta percha to occlude the pulp cavity and a viscous sealer to aid in sealing the pulp cavity. This procedure is referred to as root canal therapy. Root canal cleaning is generally achieved by hand or mechanical instrumentation with files that are configured to bore and cut.

It is also common during the root canal procedure to irrigate a pulp cavity and the various root canals involved using an endodontic irrigator tip. Irrigation assists in removing debris and necrotic material cut by the endodontic files and reamers. Disinfecting solutions can also be employed in irrigation, thereby disinfecting the pulp cavity and root canals during the operative procedure.

In addition to being thin and tight, root canals are often twisted and cumbersome to negotiate. In order to place irrigator tips at a convenient angle within a tooth and negotiate the convoluted passages of root canals, irrigator tips are typically bent. U.S. Pat. No. 4,993,941 to Maita et al., for example, discloses a dental irrigator needle having a selectively angled cannula that was designed to provide more convenient fluid delivery. U.S. Pat. No. 5,127,831 to Bab also describes a bendable flexible irrigation probe.

Another problem associated with root canal therapy is apical perforation. Before a file or irrigation tip is inserted into a root canal, the length of the root canal is determined to identify a suitable working length for the file or irrigation tip. Generally, the working length corresponds to the distance from a fixed reference position on the crown of a tooth to a location above the apical constriction of the root canal. Radiography is the most common method for measuring the length of the root canal. The preoperative x-ray image of the diseased tooth is taken from the front or back of the tooth. The length of the root canal and the desired working length of the cannula to be placed therein are then determined.

Perforation of the apex of a root canal can result from the use of files or endodontic irrigation tips that are too long. Such apical perforations typically result from an error in estimating the length of a root canal or the working length of the cannula. Similarly, the apex can be perforated by extrusion of infected material through the apex due to the force exerted by the file or tip on the material as the file or tip is pushed downward to reach the apex. In addition to exposing the tissue surrounding the tooth to the infected material, apical perforations also substantially complicate subsequent healing of the root canal.

The possibility of perforating the apex is particularly frustrating because it is often desirable to deliver fluid that reaches the apex in order to disinfect the apex and dissolve necrotic tissue therein. However, certain fluids are too viscous or the surface tension prevents certain fluids from reaching the apex if delivered too far above the apex. Sodium hypochlorite, for example, is a widely used, strong disinfectant that, because of surface tension issues can stick in the pulp chamber rather than reaching the apex if not delivered with precision from the appropriate location above the apex. Moreover, to truly irrigate necrotic debris it is often advisable to have the irrigant be delivered distal to the debris. Attempts to deliver the solution from the appropriate location, however, may result in the perforation of the apex.

Practitioners have made some attempts to place irrigator tips within teeth without perforating the apex. The working length of endodontic irrigator tips is sometimes limited by (i) bending the tips to prevent them from extending too far into a root canal, or (ii) marking the tips with a pen at a location on the tips which should not extend past the rim of the crown. The problem with each of these approaches, however, is that they are unreliable, and can contaminate the tip as a result of the handling of the tip prior to use. In addition, bending a cannula can crimp or kink the cannula.

The possibility of perforating the apex of the root canal with an endodontic file is sometimes prevented by employing a removable stop that is placed about the distal insertion end of the file and pushed a desired distance toward the proximal gripping end of the file. Such adjustable stops, however, are prone to slip and slide along the longitudinal axis of the file, thereby allowing perforation of the apex. In addition, placing a stop on the file requires handling of the file prior to use, possibly contaminating the file. One solution to this was the use of a movable collar or neck on the irrigation probe as described in U.S. Pat. No. 6,079,979 to Riitano. This probe is similar to the probe described in U.S. Pat. No. 6,422,865 to Fisher, again without a suction or aspirating portion. However, this movable collar does not address the problem of the caustic irrigant solution as described below.

One of the greatest complications of endodontic root canal irrigation is leakage of the irrigant fluid, which is often sodium hypochlorite or other caustic antiseptic solution, onto the mucosa of the mouth (gums, gingivae, etc). For example, injection of the irrigant into the periapical tissues can cause necrosis of these tissues, i.e., bone and periodontal ligament, causing a severe and painful chemical burn. Often an operator must put the aspirating tip of a surgical vacuum handle directly on the surface of the crown next to the irrigator needle in order to aspirate the waste irrigant solution before it spills onto the oral mucosa and causes a severe chemical burn. For practitioners that do not use sterilizing irrigant, but rather use water or normal saline, the greatest danger is splash-back onto the operator, increasing their danger of acquiring hepatitis, HIV, and other infectious diseases. Thus, simultaneous aspiration is important in this instance also. This is a very cramped environment with both the irrigating syringe and probe and the surgical aspiration vacuum handle in the patient's mouth. U.S. Pat. Appl. No. 2006/0259014 to Yarger describes a typical aspirator sleeve and handle for this purpose. U.S. Pat. No. 4,272,288 to Yoshii et al. describes an irrigation pen that permits continuous irrigation of a root canal, but no simultaneous aspiration.

U.S. Pat. No. 3,807,048 to Malmin describes an endodontic gun that can inject, irrigate, and evacuate for this purpose, but it is not a simple syringe technology, involves the use of valves, and can only sequentially irrigate and aspirate, rather than simultaneously irrigate and aspirate. U.S. Pat. Nos. 5,203,697, 5,490,779, and 5,540,587 to Malmin also describe an endodontic device that can aspirate and inject, but again sequentially, rather than simultaneously.

Thus, there is a need for an irrigation probe and syringe that can deliver irrigant solution to the apex of the tooth and simultaneously aspirate necrotic debris and spent irrigant solution before it burns the mouth or splashes back on the operator.

Analogous to an infected root canal, deep penetrating wounds (human and animal bites, stab wounds, penetrating wounds from a wooden branch, etc), must be irrigated to remove foreign material, necrotic debris, infection, and pus. Typically a rigid or flexible cannula is placed into the wound and the wound is irrigated with normal saline. The position of the probe or cannula is important so that further penetration into normal tissue does not occur, thus, a mechanism to keep the cannula at the correct level is important. Irrigation of a penetrating wound is a very messy procedure, and the irrigant solution often splashes back at the operator and assistant, increasing their danger of acquiring hepatitis, HIV, and other infectious diseases. Thus, simultaneous aspiration at the wound surface would be advantageous for penetrating wounds also.

Open or superficial wounds, similarly to penetrating wounds, must also be irrigated to remove foreign material, necrotic debris, infection, and pus. Although the position of the irrigation probe or cannula is not as critical as in endodontic root canals or penetrating wounds, the procedure for superficial wounds is also very messy with extreme splash back, again endangering the operator and assistant. U.S. Pat. No. 5,941,859 to Lerman discloses a splash shield, aspiration port, and irrigation probe that permit both aspiration and irrigation of superficial or flat wounds; however, the aspiration and irrigant ports are not collinear or one residing within the other. This type of technology would not function for root canals or deep penetrating wounds.

One type of suction catheter is disclosed in U.S. Pat. No. 3,375,828 to Sheridan in which a rolled up sleeve can be unrolled over the airway control aperture to apply suction in the nose, mouth, pharynx, trachea, bronchi, or other cavity in the body of a patient. In U.S. Pat. No. 3,982,540 to Ross, a multilumen tube is disclosed in which there are a plurality of spaced suction apertures in the outside wall of the negative pressure tube and a plurality of spaced positive pressure apertures, each located behind a suction aperture, to dislodge particles blocking the suction apertures. In U.S. Pat. No. 4,014,333 to McIntyre, a combined irrigation and aspiration instrument is disclosed for use in ophthalmic surgery wherein an inner and an outer tube of straight rigid material are provided in fixed relationship, the suction tip of the inner tube projecting beyond the irrigation tip of the outer tube, so that the debris-receiving, suction inlet opening is in front of, and beyond the annular pressurized irrigation outlet opening. The above mentioned Ross and McIntyre patents, which disclose combined suction and irrigation, both teach the placement of the pressurized liquid outlets in rear of the suction inlets and both teach a fixed relationship of the irrigation tube and the suction tube, so that the irrigation tube cannot be easily and quickly removed.

In addition to the above patents, there is a line-of-road vacuum cleaning apparatus, typified in the patents listed below in which there are debris-receiving inlets and/or suction inlets combined with air pressure outlets for dislodging debris. However, these patents also teach placing the air outlet in rear of, or flush with, the suction, or debris-receiving, inlet, including U.S. Pat. No. 2,990,019 to Finn, U.S. Pat. No. 3,221,358 to Dickson, and U.S. Pat. No. 3,447,188 to Maasbery. U.S. Pat. No. 5,447,494 to Dorsey, U.S. Pat. No. 5,573,504 to Dorsey, and U.S. Pat. No. 4,468,216 to Muto attempted to address this problem, by providing a catheter that simultaneously irrigates and aspirates by means of an irrigation cannulae residing within a suction cannula with or without valves; however, these provide only point irrigation-suction which is not optimal for root canal or deep penetrating wounds, the suction sleeve is not adjustable, does not provide continuous suction, does not prevent perforation, and does not provide splash back protection at the surface of the tooth or wound. U.S. Pat. Nos. 6,394,996 and 6,878,142 to Lawrence et al. disclose a catheter for irrigating tract wounds with or without a splash shield. However, the suction source is not adjustable and is parallel to the irrigation cannula rather than being a sleeve, and is a complex gun set up, rather than a simple syringe with vacuum. U.S. Pat. No. Des. 365146 to Olson discloses a wound debridement tip with an aspirator sleeve, but the sleeve is not adjustable, and the device cannot be used on a conventional syringe. Thus, although an improvement, these devices do not provide the qualities needed for root canal or wound irrigation.

There is therefore a need for an irrigation probe and syringe that can be reliably positioned to prevent distal perforation of the root canal or wound and can irrigate with saline, water, or caustic solutions while simultaneously aspirating the spent irrigant solution and necrotic debris, preventing chemical burns to surrounding tissues, and minimizing hazardous splash back at the operator.

### SUMMARY OF THE INVENTION

An endodontic or periodontic irrigation and aspiration device comprises a conventional or non-conventional syringe, an irrigation probe of various designs and manufacturers, and an aspirating sleeve in which the irrigation probe resides. The aspirating sleeve can be adjustable on the length of the irrigation probe so that different depths of root canals or periodontal recesses can be irrigated with the sleeve aspirating on the crown of the tooth or the mucosal surface of the periodontal tissues, respectively. The aspirating sleeve can be plastic vacuum tubing that is penetrated by the irrigation probe and movable on the shaft of the probe or it can be a dedicated movable sleeve with a fitting to permit attachment of vacuum tubing. The vacuum tubing can have a proximal fitting, similar to a surgical vacuum handle, to permit access to conventional dental suction vacuum equipment so that the device can be immediately applicable to all dental, periodontal, and endodontic offices and practices. The irrigation and aspiration device can prevent caustic irrigation solution from damage the mucosa of the mouth.

A penetration or tract wound irrigation and aspiration device comprises a conventional or non-conventional syringe, wound irrigation probe of various designs and manufacturers, and an aspirating sleeve in which the irrigating probe resides. The aspirating sleeve can be adjustable on the length of the irrigation probe so that different depths of penetrating or tract wounds can be irrigated with the sleeve aspirating on the skin surface to prevent splash-back on the operator. The aspirating sleeve can be plastic vacuum tubing that is penetrated by the irrigation probe and movable on the shaft of the probe or can be a dedicated movable sleeve with a proximal fitting to permit attachment of vacuum tubing. A splash shield can be integrated into the vacuum aspiration sleeve. The vacuum tubing can have a proximal fitting, similar to a surgical vacuum handle or medical vacuum tubing, to permit access to conventional medical suction vacuum equipment so that the device can be immediately applicable to all medical and hospital offices and practices.

An open or superficial wound irrigation and aspiration device comprises a conventional or non-conventional syringe, wound irrigation probe of various designs and manufacturers, and an aspirating sleeve in which the irrigating probe resides. The aspirating sleeve can be fixed on the length of the irrigation probe and comprises a rigid or flexible splash shield with the sleeve aspirating on the wound surface to prevent splash-back. A flexible vacuum splash shield permits suction to be applied across the wound surface permitting better debridement and greater splash protection. The aspirating sleeve can be plastic vacuum tubing that can be penetrated by the irrigation probe and movable on the shaft of the probe or can be a dedicated movable sleeve with a fitting to permit attachment of vacuum tubing. A splash shield can be integrated into the vacuum aspiration sleeve. The vacuum tubing can have a proximal fitting, similar to a surgical vacuum handle or medical vacuum tubing, to permit access to conventional medical suction vacuum equipment so that the device can be immediately applicable to all medical and hospital offices and practices.

Kits featuring different irrigation probes, such as probes having cannulae with a variety of different working lengths and diameters and designs with an adjustable aspirating sleeves and various sizes and types of syringes and irrigation sources can be provided, thereby enabling the practitioner to treat root canals and wounds of varying sizes and depths and irrigant volume requirements.

### BRIEF DESCRIPTION OF THE DRAWINGS

The accompanying drawings, which are incorporated in and form part of the specification, illustrate the present invention and, together with the description, describe the invention. In the drawings, like elements are referred to by like numbers.

FIG. 1 is a schematic illustration of an irrigation probe with an aspiration sleeve comprising various diameters of vacuum tubing most appropriate for endodontic and periodontal irrigation.

FIG. 2 is a schematic illustration of an irrigation probe with an aspiration sleeve comprising a dedicated vacuum housing with a fitting for vacuum tubing.

FIG. 3 is a schematic illustration of an irrigation probe with an aspiration sleeve incorporating a movable splash shield most appropriate for penetrating or tract wound irrigation.

FIGS. 4A and 4B are schematic illustrations of an irrigation probe with a removable stylet and aspiration sleeve with or without movable splash shield most appropriate for inserting a flexible irrigation probe into a penetrating or tract wound.

FIG. 5 is a schematic illustration of an irrigation probe or cannula with an aspiration sleeve incorporating immovable, but flexible or rigid, splash shield most appropriate for open or superficial wounds.

FIGS. 6A-6C are schematic illustrations of an irrigation probe with an aspiration sleeve and different irrigant sources.

FIG. 7 is a schematic illustration of an irrigation probe and aspiration sleeve with a double barrel reciprocating syringe that simultaneously provides injection and aspiration.

FIGS. 8A-8C are schematic illustrations of an irrigation probe showing a movable aspiration sleeve in different positions relative to the tip of the irrigation probe.

FIG. 9 is a schematic illustration of a typical kit having an irrigation probe and aspiration sleeve comprising various diameters of vacuum tubing, syringe, and vacuum fitting most appropriate for endodontic and periodontal irrigation.

FIG. 10 is a schematic illustration of an irrigation probe and aspiration sleeve comprising various diameters of vacuum tubing, and syringe showing irrigation and aspiration of caustic irrigant solution typically used in endodontic irrigation.

### DETAILED DESCRIPTION OF THE INVENTION

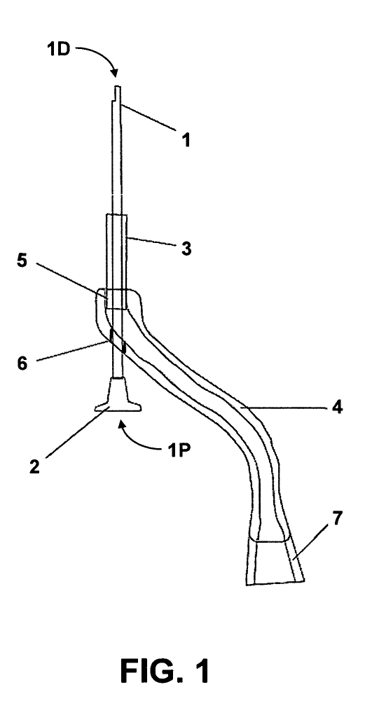

With reference now to FIGS. 1 to 10, the irrigation and aspiration device of the present invention is described. The irrigation and aspiration device comprises an irrigation probe, or cannula, and an aspiration sleeve that ensheathes the probe. The device has a distal end and a proximal end. The aspiration sleeve can prevent the insertion of the distal end of the probe beyond a desired distance, thereby preventing perforation of the apex of a root canal or wound, and also aspirates any excess irrigation solution and free debris. The distal stop end of the aspiration sleeve can have a substantially greater diameter than the diameter of the distal end of the probe. Thus, the stop end of the sleeve can rest on the occlusal surface of the crown of a tooth or wound while the distal end of the probe extends the desired distance within the root canal or wound. The irrigation and aspiration device can be used for convenient delivery of a variety of different liquids to a root canal, periodontal recess or wound, such as debriding agents, lubricants, anti-bacterial agents, chelating agents, water, hypochlorite, ablating agents, alcohol, contrast, or other injectables.

FIG. 1 is a schematic illustration of an irrigation probe with an aspiration sleeve, or sheath, comprising various diameters of vacuum tubing most appropriate for endodontic and peridontal irrigation. The device has a distal end and a proximal end. Irrigation probe 1 can be a rigid, bendable, or flexible irrigation needle, catheter, cannula, or similar probe and an appropriate fitting 2 at the proximal end 1P for a syringe or other fluid source to deliver irrigant from a tip at the distal end 1D of the probe. Irrigation probe 1 is ensheathed within an aspiration sleeve 3 which can be a flexible or rigid hollow sheath for vacuum aspiration. The aspiration sleeve 3 can be collinear with the shaft of the probe 1. The aspiration sleeve 3 can be part of or connected to vacuum tubing 4 by an air-tight bond 5, and can be movable on the shaft of the probe 1 with a contact point at an air-tight junction 6. The air-tight junction 6 can comprise a through opening in the wall of the tubing 4. The air-tight junction 6 thereby enables the probe 1 to slide and change positions relative to the aspiration sleeve 3. The vacuum tubing 4 can be connected to a vacuum source by means of a proximal vacuum fitting 7. The vacuum tubing 4 is most favorably constructed of Tygon, but can be of any flexible polymer or plastic. Similarly, the aspiration sleeve 3 can be constructed of Teflon tubing, but can be constructed of Tygon, or any biocompatible polymer or plastic or other flexible or rigid material.

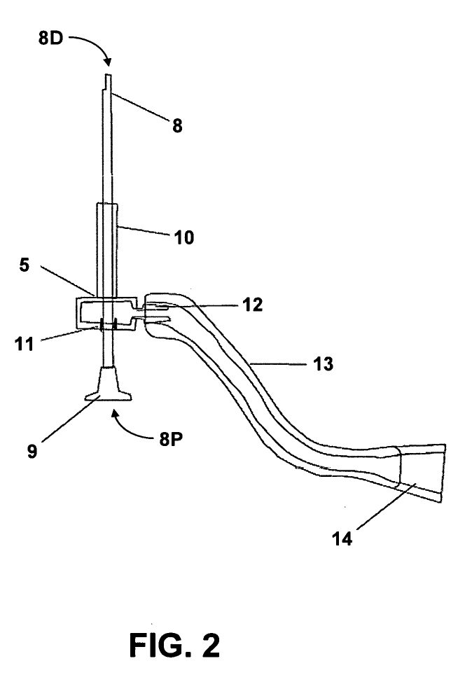

FIG. 2 is a schematic of an irrigation probe with an aspiration sleeve comprising a dedicated vacuum housing with a fitting for vacuum tubing. Irrigation probe 8 can be a rigid, bendable, or flexible irrigation needle, catheter, cannula, or similar probe with an appropriate fitting 9 at the proximal end 8P for a syringe or other fluid source to deliver irrigant from a tip at the distal end 8D of the probe. Irrigation probe 8 resides in and can be collinear with a hollow aspiration sleeve 10 for vacuum aspiration. The aspiration sleeve 10 can be flexible and can be part of or connected to the vacuum housing 11 with an air-tight bond 5. The vacuum housing 11 comprises a fitting 12 attached to vacuum tubing 13 and can be movable on the shaft of the probe 8 with a contact point at an air-tight junction. The vacuum tubing 13 can be connected to a vacuum source by means of a fitting 14.

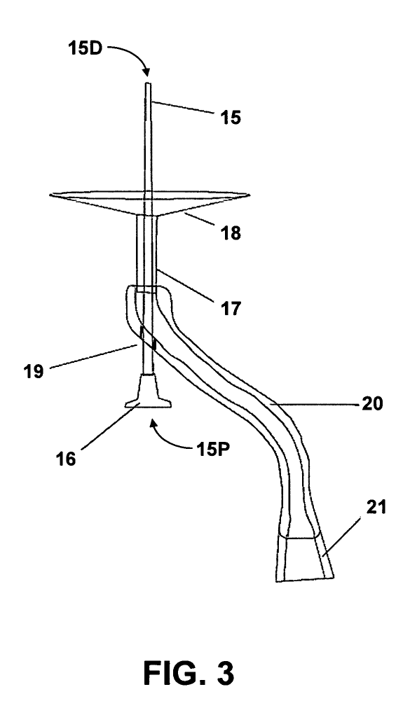

FIG. 3 is a schematic illustration of an irrigation probe with an aspiration sleeve incorporating a movable splash shield most appropriate for penetrating or tract wound irrigation. Irrigation probe 15 can be a rigid, bendable, or flexible irrigation needle, catheter, cannula, or similar probe with an appropriate fitting 16 at the proximal end 15P for a syringe or other fluid source to deliver irrigant from a tip at the distal end 15D of the probe. Irrigation probe 15 resides in and can be collinear with an aspiration sleeve 17 that has a flexible or rigid vacuum splash shield 18. As in FIGS. 2 and 3, there is an airtight junction 19 between the probe 15 and housing or vacuum tubing 20, and a fitting 21 to attach to a vacuum source. The splash shield 18 can comprise a conical, hemispherical, or other geometric structure of rigid or flexible plastic material, preferably nearly or completely transparent. Splash shield 18 and sleeve 17 can be movable on the shaft of the irrigation probe 15, so that the splash shield 18 can remain on the surface of the skin while the irrigation probe 15 can be inserted to different depths in the penetrating or tract wound.

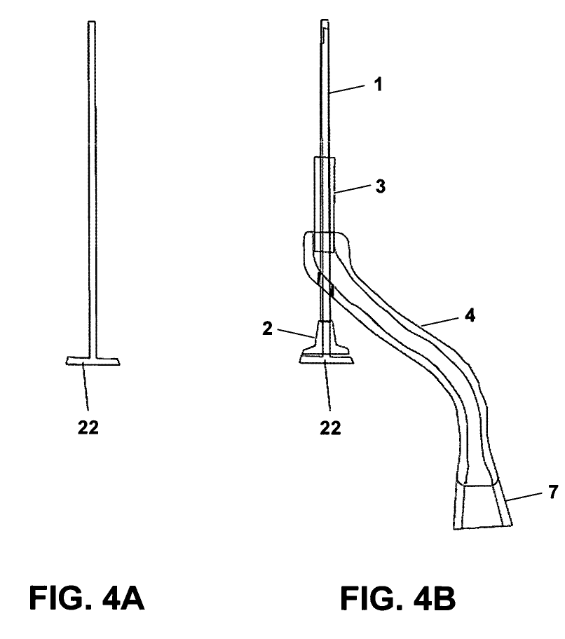

FIGS. 4A and 4B are schematic illustrations of the exemplary irrigation probe 1 and aspiration sleeve 3 of the type shown in FIG. 1, with or without a movable splash shield, and a removable stylet 22, as shown in FIG. 4A. This device is most appropriate for inserting a flexible irrigation probe into a penetrating or tract wound. As shown in FIG. 4B, the stylet 22 can be placed in the flexible irrigation probe 1, directed into the tract or penetrating wound to the correct depth, and then can be removed. The irrigation probe 1 can then be attached to an irrigant fluid source with a fitting 2.

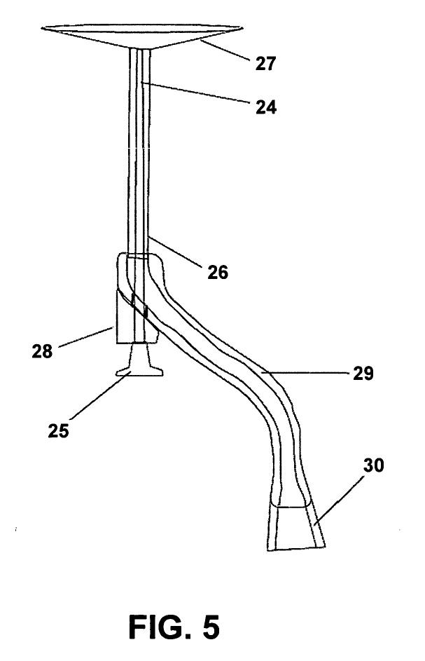

FIG. 5 is a schematic illustration of an irrigation probe with an aspiration sleeve incorporating an immovable, but flexible or rigid, splash shield most appropriate for open or superficial wounds. Irrigation probe 24 can be a rigid, bendable, or flexible irrigation needle, catheter, cannula, nozzle, or similar probe with an appropriate fitting 25 for a syringe or other fluid source. Irrigation probe 24 resides in a hollow aspiration sleeve 26 that has a flexible or rigid vacuum splash shield 27. There can be an air-tight junction 28 and support between a housing or vacuum tubing 29, and a fitting 30 to attach to a vacuum source. Vacuum splash shield 27 and sleeve 26 can be immovable on the shaft of the irrigation probe 24, so that the splash shield 27 can remain on the surface of the skin.

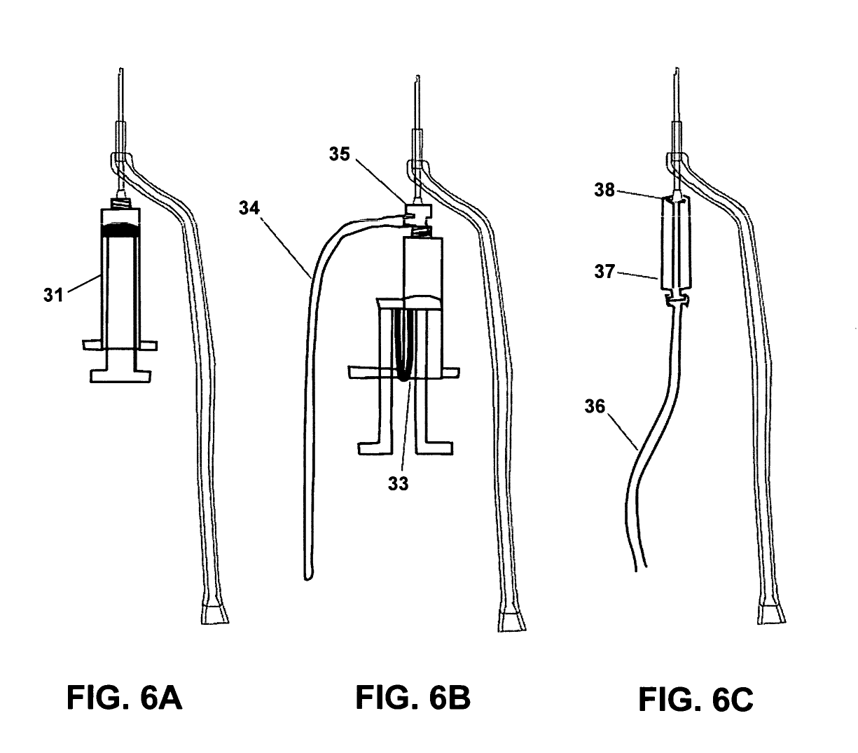

FIGS. 6A to 6C are schematic illustrations of the exemplary irrigation probe and aspiration sleeve shown in FIG. 1 with different irrigant sources. FIG. 6A shows the irrigation probe with a conventional syringe 31. FIG. 6B shows the irrigation probe with a refilling syringe 33 and fluid tubing and fluid source 34 with double one-way valves 35 to permit refilling of the syringe. Syringes as described in U.S. Pat. No. 6,245,046, U.S. Pat. No. 6,962,576, U.S. Pat. No. 7,118,554, and U.S. Pat. Appl. No. 2006-18410-A1 to Sibbitt et al. are examples of such refilling syringes. FIG. 6C shows a continuous or adjustable fluid source 36 in a handle or pen 37 with on-off valve 38, similar to the handle described in U.S. Pat. No. 4,272,288 to Yoshii et al.

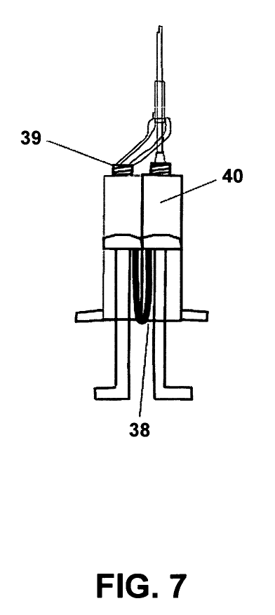

FIG. 7 is a schematic illustration of an irrigation probe and aspiration sleeve with a double barrel reciprocating syringe 38 that simultaneously provides for irrigant injection and aspiration. In this embodiment, the vacuum tubing or vacuum housing is provided vacuum by attaching to the accessory barrel needle fitting 39 of the double barrel reciprocating syringe 38, while the irrigation probe is attached to the needle fitting to the injection barrel 40 of the reciprocating syringe. Syringes as described in U.S. Pat. No. 6,245,046, U.S. Pat. No. 6,962,576, U.S. Pat. No. 7,118,554, and U.S. Pat. Appl. No. 2006-18410-A1 to Sibbitt et al. are examples of such reciprocating syringes.

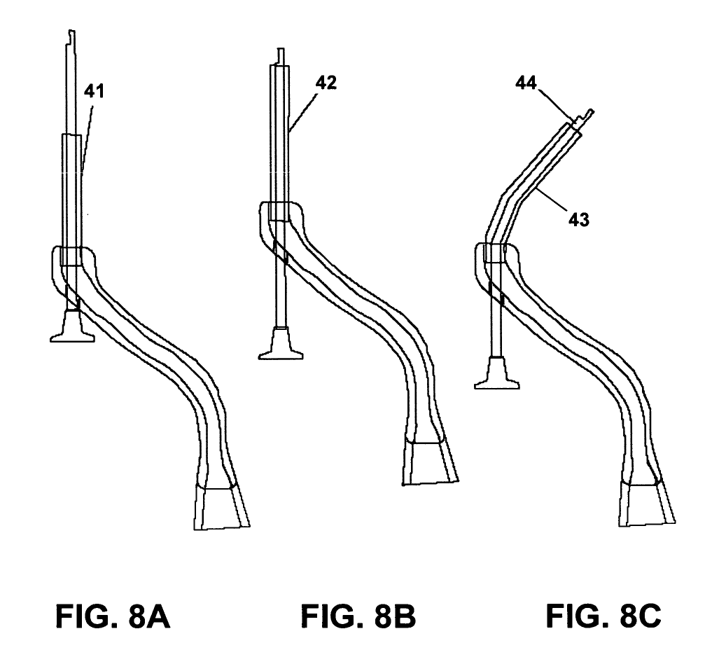

FIGS. 8A to 8C are schematic illustrations of an irrigation probe showing a movable aspiration sleeve in different positions relative to the tip of the irrigation probe by movable and reversible sliding of the sleeve along the shaft or the straight or bent needle or probe. FIG. 8A shows the aspiration sleeve in a retracted position 41 as would be used for a deep root canal or wound irrigation. FIG. 8B shows the aspiration sleeve in an extended position 42 for a shallow irrigation. FIG. 8C shows the aspiration sleeve in a fixed position 43 around an intentionally bent needle or probe 44.

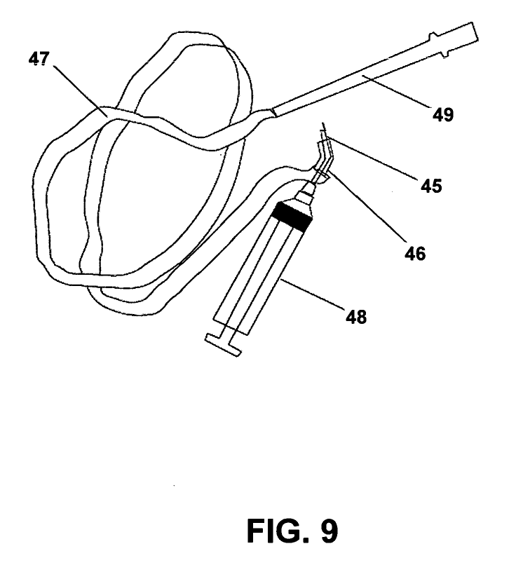

FIG. 9 is a schematic illustration of a typical kit with irrigation probe 45 and aspiration sleeve 46 comprising various diameters of vacuum tubing 47, irrigation syringe 48, and vacuum fitting 49 most appropriate for endodontic and peridontal irrigation.

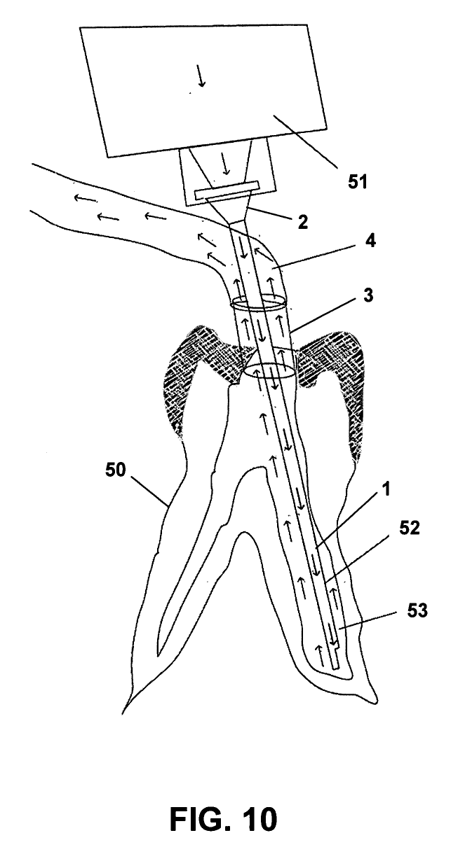

FIG. 10 is a schematic illustration of the exemplary irrigation probe and aspiration sleeve of the type shown in FIG. 1 with a syringe for use with irrigation and aspiration of caustic irrigant solution typically used in endodontic irrigation. Irrigant is expelled from the irrigation syringe or fluid source 51, the irrigant moves down the irrigation probe 1 into the root canal 52 of a tooth 50 or a wound to a skin, the irrigant circulates back up root canal or wound carrying debris 53, and the irrigant is aspirated by the aspiration sleeve 3 at the surface of the tooth or skin.

The present invention has been described as an irrigation and aspiration device. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. An irrigation and aspiration device for irrigating and aspirating a root canal of a tooth or a wound to a skin, comprising:
a. an irrigation probe comprising a hollow shaft having a distal end and a proximal end, for irrigating the root canal or wound with an irrigant from a tip at the distal end of the hollow shaft;
b. means for delivering the irrigant to the probe;
c. a hollow aspiration sleeve that ensheathes the probe, the sleeve having a distal end and a proximal end, for aspirating the root canal or wound from a suction inlet at the distal end of the sleeve; and
d. means for providing a vacuum to the aspiration sleeve, wherein the outer perimeter of the proximal end of the shaft of the probe makes a substantially air-tight junction with a through opening in the vacuum providing means such that the irrigation probe is movable within the aspiration sleeve.

2. The irrigation and aspiration device of claim 1, wherein the hollow shaft of the irrigation probe is collinear with the hollow aspiration sleeve.

3. The irrigation and aspiration device of claim 1, wherein the irrigation probe is rigid, bendable, or flexible.

4. The irrigation and aspiration device of claim 1, wherein the irrigation probe comprises a needle, catheter, cannula, or nozzle.

5. The irrigation and aspiration device of claim 1, wherein the irrigant delivering means comprises a fitting at the proximal end of the irrigation probe for delivery of the irrigant thereto.

6. The irrigation and aspiration device of claim 1, wherein the irrigant delivering means comprises a handle with an on-off valve for continuous delivery of the irrigant.

7. The irrigation and aspiration device of claim 1, wherein the irrigant delivering means comprises a syringe.

8. The irrigation and aspiration device of claim 7, wherein the syringe comprises a refilling syringe.

9. The irrigation and aspiration device of claim 8, wherein the refilling syringe comprises double one-way valves for refilling the syringe.

10. The irrigation and aspiration device of claim 1, wherein the irrigant delivering means and vacuum providing means comprise a reciprocating syringe.

11. The irrigation and aspiration device of claim 10, wherein the reciprocating syringe comprises an accessory barrel for providing vacuum to the aspiration sleeve and an injection barrel for delivery of the irrigant to the irrigation probe.

12. The irrigation and aspiration device of claim 1, wherein the aspiration sleeve is flexible or rigid.

13. The irrigation and aspiration device of claim 1, wherein the aspiration sleeve comprises a hollow vacuum tube.

14. The irrigation and aspiration device of claim 1, wherein the vacuum providing means comprises vacuum tubing having an air-tight bond to the proximal end of the aspiration sleeve.

15. The irrigation and aspiration device of claim 1, wherein the vacuum providing means comprises a vacuum housing having an air-tight bond to the proximal end of the aspiration sleeve, the air-tight junction with the proximal end of the irrigation probe, and a fitting for connection of a vacuum source thereto.

16. The irrigation and aspiration device of claim 1, further comprising a stylet that can be inserted into and removed from the proximal end of the hollow shaft of the irrigation probe.

17. The irrigation and aspiration device of claim 1, further comprising a splash shield attached to the outer perimeter of the aspiration sleeve to prevent splash back at an operator.

18. The irrigation and aspiration device of claim 17, wherein the splash shield is movably or fixedly attached to the outer perimeter of the aspiration sleeve.

19. The irrigation and aspiration device of claim 17, wherein the splash shield comprises a conical or hemispherical structure.

20. The irrigation and aspiration device of claim 17, wherein the splash shield is flexible or rigid.

21. The irrigation and aspiration device of claim 17, wherein the splash shield is transparent.
